(19) United States
(12) Patent Application Publication
(10) Pub. No.: US 2025/0020503 A1
(43) Pub. Date: Jan. 16, 2025

(54) A SYSTEM FOR OPERATING A FOOD SERVING SYSTEM

(71) Applicant: TURUN YLIOPISTO, Turun yliopisto (FI)

(72) Inventors: Pauliina OJANSIVU, Turun yliopisto (FI); Lauri KOIVUNEN, Turun yliopisto (FI); Mari NORRDAL, Turun yliopisto (FI)

(21) Appl. No.: 18/715,893

(22) PCT Filed: Nov. 30, 2022
(86) PCT No.: PCT/FI2022/050802

§ 371 Date: Jun. 3, 2024

(30) Foreign Application Priority Data
Dec. 1, 2021 (FI) 20216230

(51) Int. Cl. G01G 19/414

(52) U.S. Cl. CPC G01G 19/4146

(57) ABSTRACT

According to an aspect, there is provided a system for managing a food serving system. The food collected by a user is weighed and sensor data, for example, image data about the food collected by the user is obtained. This data may be used as training data for a machine learning algorithm to build a model enabling a subsequent classification of food based at least on sensor data associated with the food.

### TECHNICAL FIELD

The present disclosure relates to the field of data processing in general, and to a solution for operating a food serving system and for managing the food serving system and a machine learning solution for interpretating and analyzing acquired and collected data.

### BACKGROUND

There exists solutions for tracking the amount of consumed food by people having, for example, a lunch, and linking the consumed food to identified users. For example, a line serving lunch may be provided with weighing devices in connection with the served dishes and readers for reading user-associated identifiers, for example, from smart cards. At a specific food collecting point, the user may first be identified with the smart card, and after that, the user may take a desired amount of a dish or food. The amount taken by the user is weighed and the weight information is associated with the user. By identifying the user at multiple food collecting points and associating the food weight information with the user, it is possible determine, for example, energy contents of the food selected by the user.

However, even if the weight and energy content may be determined accurately based on the measurements, this information is available only if the food collected by the user and the amount of collected food is measured at the time of collecting the food. Furthermore, detailed information regarding nutritional values cannot be plausibly and accurately determined by weight only, and it requires additional parameters and analysis in order to give additional information to an end user and a service provider.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the present disclosure to provide a technical solution for classifying food content based on sensor data, for example, imaging data stored about the food.

The object above is achieved by the features of the independent claims in the appended claims. Further embodiments and examples are apparent from the dependent claims, the detailed description and the accompanying drawings.

According to a first aspect, there is provided a system comprising a plurality of food serving points configured to serve food, each food serving point being configured to serve a predetermined dish, each food serving point being associated with a weighing device configured to weigh the amount of the food collected from the food serving point to provide a weighing result, and a reader configured to read an identifier associated with a food collecting session of a user; at least one sensing point, each sensing point comprising at least one sensor configured to provide sensor data about the food collected by the user and a reader configured to read the identifier associated with the food collecting session of the user; a managing system configured to store data relating to food served in each of the plurality of food serving points, obtain the weighing result and the identifier from each food serving point, and associate weighing results having the same identifier with each other; a training system configured to obtain sensor data originating from the at least one sensing point, the sensor data being associated with the identifier, obtain the weighing results associated with the identifier and the data relating to food served in the plurality of food serving points from the managing system, and use at least the obtained sensor data associated with the identifier, the weighing results associated with the identifier and the data relating to food served in the plurality of food serving points as training data for a machine learning algorithm to build a model enabling a subsequent classification of food based at least on sensor data associated with the food.

In an implementation form of the first aspect, the system further comprises a control unit configured to receive a trigger event; and trigger storing of an image of the food collected by the user with the at least one camera.

In an implementation form of the first aspect, the control unit is configured to receive the trigger event from the reader.

In an implementation form of the first aspect, the system further comprises a control unit and a sensing point at each of the plurality of food serving points, the control unit of a food serving point being configured to receive a trigger event; and trigger storing of sensor data associated with the food collected by the user with the at least one sensor of the sensing point.

In an implementation form of the first aspect, the control unit is configured to receive the trigger event from the reader associated with the food serving point.

In an implementation form of the first aspect, the control unit is configured to receive the trigger event from the weighing device associated with the food serving point.

In an implementation form of the first aspect, the data relating to food served in the plurality of food serving points comprises at least one of: the food served by each of the plurality of food serving points, and nutrient content information associated with each food served by each of the plurality of food serving points.

In an implementation form of the first aspect, the data system is configured to generate a session having a session identifier when obtaining the identifier for the first time and determining that there does not exist an active session, associate a session start time with the session, and link the identifier with the session having the session identifier.

In an implementation form of the first aspect, the system further comprises a user identifier reader, and the data system is configured to obtain a user identifier from the user identifier reader, and associate the user identifier with the session.

In an implementation form of the first aspect, the identifier comprises a radio frequency identifier, a near filed communication identifier, a bar code, a QR code or a visually recognizable identifier associated with a tray used by the user.

In an implementation form of the first aspect, identifier comprises an identifier, a radio frequency identifier, a near filed communication identifier, a smart wearable identifier, a smart ring identifier, a fingerprint, a biometric identifier and a visually recognizable identifier associated with the user.

In an implementation form of the first aspect, wherein the system further comprises a waste collecting point comprising a weighing device configured to weigh the amount of biowaste left by the user to provide a waste weighing result; a reader configured to read the food collecting session identifier associated with the food collecting session of the user, and at least one sensor configured to provide sensor data about the food left by the user, wherein the training system is configured to obtain the waste weighing result, the food collecting session identifier associated with the food collecting session of the user and the sensor data about the food left by the user; and provide based on the obtained waste weighing result, the food collecting session identifier associated with the food collecting session of the user and the sensor data about the food left by the user additional information about the food left by the user.

In an implementation form of the first aspect, the at least one sensor comprise at least one of a camera, a stereo camera, a depth camera, a multispectral camera, an infrared camera, a RGB camera, a spectroscopy sensor, a near infrared sensor, a spectroscopy sensor, a photogrammetry sensor, a lidar sensor, a three-dimensional scanner and a photodetector.

In an implementation form of the first aspect, the training system is configured to obtain additional sensor data and manually labeled data associated with the additional sensor data; and use the obtained additional sensor data and manually labeled data as training data for the machine learning algorithm to complement the model.

According to a second aspect, there is provided a computer-implemented method comprising obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

In an implementation form of the second aspect, the method further comprises obtaining additional sensor data and manually labeled data associated with the additional sensor data; and using the obtained additional sensor data and manually labeled data as training data for the machine learning algorithm to complement the model.

In an implementation form of the second aspect, the method further comprises obtaining a waste weighting result, the food collecting session identifier associated with the food collecting session of the user and sensor data about the food left by the user; and using the obtained waste weighing result, the food collecting session identifier associated with the food collecting session of the user and the sensor data about the food left by the user as training data for the machine learning algorithm to build the model enabling a subsequent classification of food based at least on sensor data associated with the food.

In an implementation form of the second aspect, the data relating to food served in the plurality of food serving points comprises at least one of: the food served by each of the plurality of food serving points, and nutrient content information associated with each food served by each of the plurality of food serving points.

In an implementation form of the second aspect, the method further comprises receiving sensor data associated with food collected by a user; and applying the model to classify the food collected by the user based on the sensor data.

In an implementation form of the second aspect, the method further comprises receiving a weighing result associated with the food collected by the user; and applying the model to classify the food collected by the user based on the sensor data and the weighing result.

According to a third aspect, there is provided a computer program comprising instructions for causing an apparatus to perform the method of the second aspect.

According to a fourth aspect, there is provided an apparatus comprising at least one processor, and at least one memory including computer program code, the at least one memory and the computer program code configured to, with the at least one processor, cause the apparatus at least to: obtain sensor data about food collected by a user from a plurality of food serving points, the sensor data being associated with a food collecting session identifier; obtain weighing results associated with the food collecting session identifier, each weighing result providing a weight of a food collected from a food serving point; obtain data relating to food served in the plurality of food serving points; and use at least the sensor data, the weighing results and the data relating to food served in the plurality of food serving points as training data for a machine learning algorithm to build a model enabling a subsequent classification of food based at least on sensor data associated with the food.

In an implementation form of the fourth aspect, the at least one memory and the computer program code configured to, with the at least one processor, cause the apparatus at least to: obtain additional sensor data and manually labeled data associated with the additional sensor data; and use the obtained additional sensor data and manually labeled data as training data for the machine learning algorithm to complement the model.

In an implementation form of the fourth aspect, the at least one memory and the computer program code configured to, with the at least one processor, cause the apparatus at least to: obtain a waste weighting result, the food collecting session identifier associated with the food collecting session of the user and sensor data about the food left by the user; and use at least the obtained waste weighing result, the food collecting session identifier associated with the food collecting session of the user and the sensor data about the food left by the user as training data for the machine learning algorithm to build the model enabling a subsequent classification of food based at least on sensor data associated with the food.

In an implementation form of the fourth aspect, the data relating to food served in the plurality of food serving points comprises at least one of: the food served by each of the plurality of food serving points, and nutrient content information associated with each food served by each of the plurality of food serving points.

In an implementation form of the fourth aspect, the at least one memory and the computer program code configured to, with the at least one processor, cause the apparatus at least to: receive sensor data associated with food collected by a user; and apply the model to classify the food collected by the user based on the sensor data.

In an implementation form of the fourth aspect, the at least one memory and the computer program code configured to, with the at least one processor, cause the apparatus at least to: receive a weighing result associated with the food collected by the user; and apply the model to classify the food collected by the user based on the sensor data and the weighing result.

According to a fifth aspect, there is provided an apparatus comprising means for: obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

According to a sixth aspect, there is provided a method comprising: receiving sensor data associated with food collected by a user; and applying a trained machine learning model to classify the food collected by the user based on the sensor data, the trained machine learning model being obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

In an implementation form of the sixth aspect, the method further comprises receiving a weighing result associated with the food collected by the user; and applying the model to classify the food collected by the user based on the sensor data and the weighing result.

According to a seventh aspect, there is provided an apparatus comprising at least one processor and at least one memory including computer program code, the at least one memory and the computer program code configured to, with the at least one processor, cause the apparatus at least to: receive sensor data associated with food collected by a user; and apply a trained machine learning model to classify the food collected by the user based on the sensor data, the trained machine learning model being obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

In an implementation form of the seventh aspect, the at least one memory and the computer program code configured to, with the at least one processor, cause the apparatus at least to: receive a weighing result associated with the food collected by the user; and apply the trained model to classify the food collected by the user based on the sensor data and the weighing result.

According to an eighth aspect, there is provided a computer program comprising instructions for causing an apparatus to perform the method of the sixth aspect.

According to a ninth aspect, there is provided an apparatus comprising means for: receiving sensor data associated with food collected by a user; and applying a trained machine learning model to classify the food collected by the user based on the sensor data, the trained machine learning model being obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

According to a tenth aspect, there is provided a system comprising a sensing point comprising at least one sensor configured to provide sensor data about food collected by a user; a control unit configured to control the sensing point; and an analyzing unit configured to configured apply a trained model to classify the food collected by the user based at least on the sensor data to provide an estimation and/or a classification of the food taken by the user.

In an implementation form of the tenth aspect, the system may further comprise a weighing device configured to weigh the amount of the food collected by the user, the weighing device being controlled by the control unit, wherein the analyzing unit is configured to configured apply the trained model to classify the food collected by the user based at least on the sensor data and the weighing result to provide an estimation and/or a classification of the food taken by the user.

According to an eleventh aspect, there is provided a system comprising a sensing point comprising at least one sensor configured to provide sensor data about food left by a user; a control unit configured to control the sensing point; and an analyzing unit configured to configured apply a trained model to classify the food left by the user based at least on the sensor data to provide an estimation and/or a classification of the food left by the user.

In an implementation form of the eleventh aspect, the system may further comprise a weighing device configured to weigh the amount of the food left by the user, the weighing device being controlled by the control unit, wherein the analyzing unit is configured to configured apply the trained model to classify the food left by the user based at least on the sensor data and the weighing result to provide an estimation and/or a classification of the food left by the user.

Other features and advantages of the present invention will be apparent upon reading the following detailed description and reviewing the accompanying drawings.

### BRIEF DESCRIPTION OF THE DRAWINGS

The essence of the present invention is explained below with reference to the accompanying drawings in which:

FIG. 1A illustrates a system according to an example embodiment.

FIG. 1B illustrates a system according to another example embodiment.

FIG. 1C illustrates a system according to another example embodiment.

FIG. 1D illustrates a system according to another example embodiment.

FIG. 2 illustrates a signaling diagram of a method according to an example embodiment.

FIG. 3 illustrates a signaling diagram of a method according to another example embodiment.

FIG. 4A illustrates a system according to an example embodiment.

FIG. 4B illustrates a system according to an example embodiment.

FIG. 5 illustrates an apparatus that may include a variety of optional hardware and software components according to an example embodiment.

### DETAILED DESCRIPTION

In the following description, references are made to the accompanying drawings, which form part of the present disclosure, and in which are shown, by way of illustration, specific aspects, embodiments and examples in which the present disclosure may be placed. It is understood that other aspects may be utilized and structural or logical changes may be made without departing from the scope of the present disclosure. The following detailed description, therefore, is not to be taken in a limiting sense, as the scope of the present disclosure is defined by the appended claims. Further, the present disclosure can be embodied in many other forms and should not be construed as limited to any certain structure or function disclosed in the following description.

According to the detailed description, it will be apparent to ones skilled in the art that the scope of the present disclosure covers any embodiment of the present invention, which is disclosed herein, irrespective of whether this embodiment is implemented independently or in concert with any other embodiment of the present disclosure. For example, system disclosed herein can be implemented in practice by using any numbers of the embodiments provided herein. Furthermore, it should be understood that any embodiment of the present disclosure can be implemented using one or more of the elements presented in the appended claims.

As used herein, the term “food serving point” may refer to any physical location at which food is served. Further, one or more food dishes may be served at a single food serving point. In an example embodiment, each dish may be served at a separate food serving point. For example, a food serving point may comprise a location at which a served dish is arranged and from which a user may take a user-selected amount of the dish onto his/her plate. Multiple food serving points may be arranged at a single location. The food serving point may have an associated “food collecting point” at which the user may place a tray and one more dishes, for example, a plate carried by the tray. The food serving point or the food collecting point may also comprise a weighing device configured to weigh the tray positioned at the food serving point of the food collecting point.

As used herein, the term “tray” may refer to an object that can be used to carry one or more other items, for example, plates, glasses etc. The tray may take any appropriate form, for example, its shape may be rectangular, rounded rectangular, round etc. Each tray may be associated with an identifier that may uniquely identify a tray among all trays used in the food serving points. The identifier may be provided, for example, by a wirelessly readable tag, for example, a near field communication (NFC) tag, a radio frequency identification (RFID) tag or a visually readable tag. The identifier may be provided, for example, also by a visually readable code or identifier, for example, a QR code, a bar code etc. In an example embodiment, the identifier may be a characteristic of the tray itself. For example, a tag comprising the identifier may be fixedly attached to the tray, for example, glued on a bottom side of the tray or incorporated into the tray. In another example embodiment, the visually readable code or identifier may be, for example, printed on the tray or attached to the tray, for example, as a sticker. In another example embodiment, the identifier may be provided by a separate device or a tag that may be associated with a user or with the user's device. For example, a mobile device put on the tray may provide the identifier. The identifier may thus be provided, for example, via a wireless transmission, for example, by using Bluetooth, RFID, NFC, Wi-Fi, LoRa, ZigBee, LTE/4G/5G/6G etc. Thus, in an example embodiment, the identifier may be associated with a user or with a mobile device or wearable device of a user instead of the tray. Therefore, although the example embodiments discussed below may use the identifier as being associated with a tray, the identifier may alternatively be associated, for example, with a user or with a mobile device of the user (for example, a fingerprint or a biometric identifier (for example, voice, face, heartbeat etc.). Further, the identifier may be unique among the identifiers used within a specific food serving system, or the identifier may be globally unique among all identifiers. The identifier may also be unique among all identifiers used by a specific device or device type. The identifier may be, for example, a serial number or a code associated with a device or component, electromagnetic material capable of sending information, or any other identifier that can be used for identification purposes.

Further, as used herein the term “reader” may refer to any type of a reader that is able to read or recognize an identifier. The reader may apply, for example, near field communication (NFC), a radio frequency identification (RFID) or visual recognition. In another example embodiment, the reader may be a fingerprint reader, a biometric reader, a facial recognition based reader etc. The visual recognition may refer, for example, to a solution where the reader is able to read visually readable codes or identifiers, for example, QR codes, bar codes etc. Alternatively, the visual recognition may refer to a solution that is based on recognizing information from an image or images from a camera. Further, the reader may be configured to read the identifier continuously or at preset intervals. The reader may also be configured to read the identifier after receiving an instruction to read the identifier.

Further, as used herein the terms “trained model” and “machine learning training” may to a model that is being trained, or has been trained already earlier and is only then applied. The training or learning may be performed locally at a location comprising food serving points. Alternatively or additionally, the training or learning may be performed externally, for example, by edge computing, or centrally, for example, as a cloud based solution. Similarly, if applying an earlier trained model, the model may locate at the site comprising the food serving point, or externally or centrally, for example, in a cloud. In an example embodiment, the training or learning may be implemented automatically and/or independently at the location, for example, by a neuromorphic or artificial chip. In another example embodiment, the training or learning may start from the beginning. Alternatively, the training or learning may start from an existing algorithm and an existing data set.

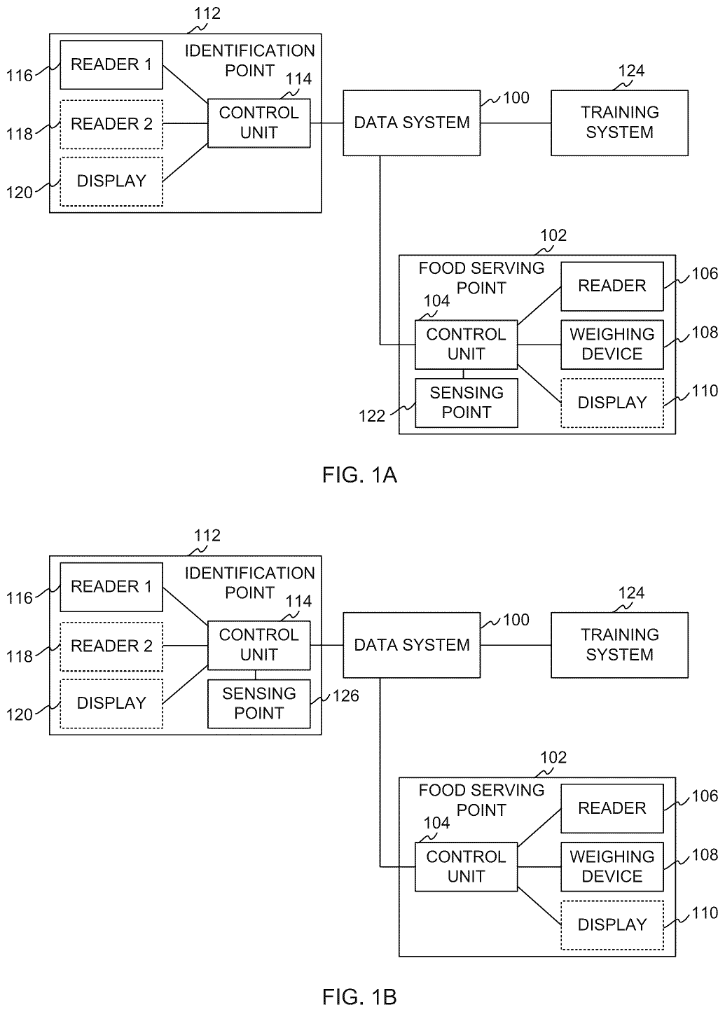

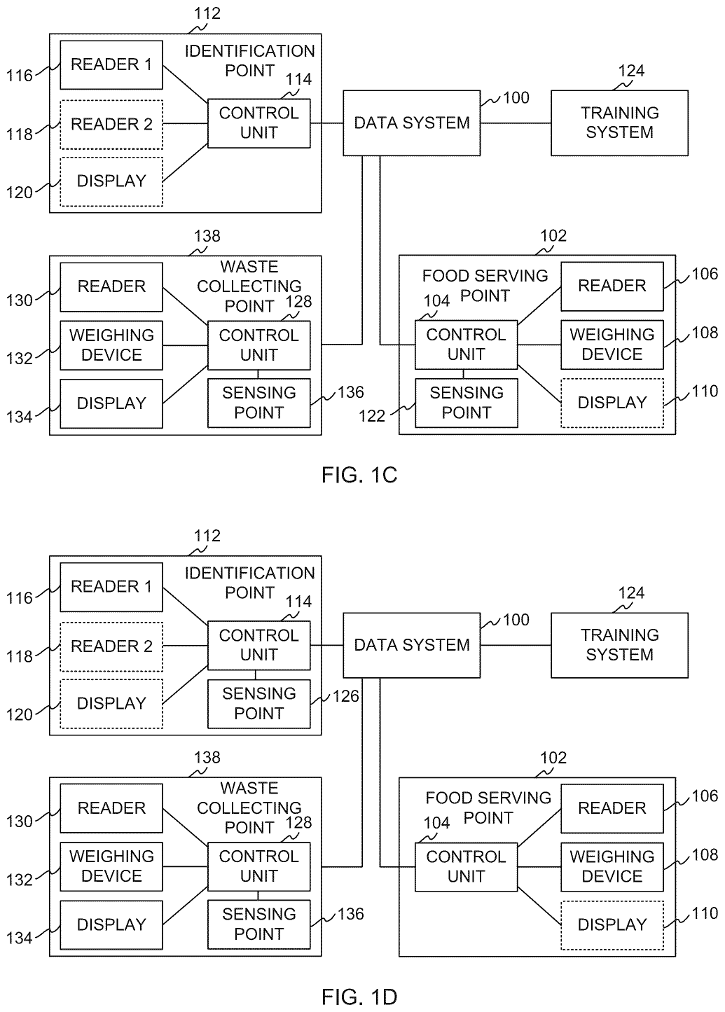

FIG. 1A illustrates a system according to an example embodiment.

The system comprises at least one food serving point 102. From the food serving point 102 a user is able to take a desired amount of food. The food serving point 102 may comprise a control unit 104, a weighing device 108 connected to the control unit 104 and being configured to weigh a tray of a user, and a reader 106 connected to the control unit 104 and being configured to read an identifier associated with the tray. The food serving point 102 may also comprise a display 110 configured to display information associated with the food serving point 102. The control unit 104 associated with the food serving points 102 may be configured to start a weighing event when detecting a change in weight with the weighing device 108 associated with the food serving point 102. In response to the start, the control unit 104 may be configured to associate the identifier associated with the tray read with the reader 106 with the weighing event. Further, the control unit 104 may be configured to generate at least one weighing result with the weighing device 108 and to stop the weighing event when detecting no weight with the weighing device 108. In addition to the food serving point 102, the system may comprise one or more additional food serving points which are not associated with weighing devices, for example, a grill point, a dessert point, a beverage point, a soup point, salad point, bread point etc. The weighing device 108 may be configured to measure a decrease in weight of a container from which the user collects the food. Alternatively or additionally, the weighing device 108 may be configured to measure an increase in weight of the tray carrying a plate or a bowl to which the user places the collected food. In other words, the weighing measurement may be implemented with the tray (by a built-in weighing device), at the location to which the user places his/her tray beside the food serving point or at the food serving point (measuring decrease in weight of the food collected by the user).

In an example embodiment, the reader 106 may be configured to read the identifier, for example, continuously or at preset intervals. In another example embodiment, the reader 106 may be configured to read the identifier after receiving an instruction to read the identifier. Further, when the control unit 104 associates the identifier read with the reader 106 with the weighing event, the control unit 104 may use the last read identifier as the identifier to be associated with the weighing event. Alternatively, when the control unit 104 starts the weighing event, the control unit 104 may be configured to instruct the reader 106 to read the identifier and associate the read identifier with the weighing event. Further, in an example embodiment, if the control unit 104 receives a read identifier from the reader 106 after the weighing event has already started, the control unit 104 may set this identifier as the identifier associated with the weighing event.

The food serving point 102 may also comprise a sensing point 122 or a separate sensing point 122 associated with the food service point 102. The sensing point 122 may comprise at least one sensor configured to provide sensor data about the food collected by the user. The at least one sensor may comprise at least of the following: a camera, a stereo camera, a depth camera, a multispectral camera, a hyperspectral camera, an infrared camera, a RGB camera, an ultraviolet camera, a spectroscopy sensor, a near infrared sensor, a spectroscopy sensor, a photogrammetry sensor, a lidar sensor, a three-dimensional scanner and a photodetector. Different sensors may provide different accuracy levels depending on a type of food, and thus more than one sensor may be used to provide more accurate sensor data about the food collected by the user. One or more of the sensors may be configured to detect at wavelengths of 200-1700 nm, 280-1550 nm, 315-1380 nm, 380-1000 nm, 390-900 nm or 400-800 nm. The sensing point 122 may be positioned so that the at least one sensor is able to provide sensor data, for example, image data about the food collected by the user from the food serving point 102. One possible location for the at least one sensor may be above a counter on which the tray is placed when the user collects food from the food serving point 102. Thus, the at least one sensor is able to store the sensor data about the food collected by the user. The data provided associated with the identifier provided by the at least one sensor may be sent to the data system 100. Alternatively or additionally, the data may be sent directly to a training system 124.

In an example embodiment, the system may also comprise at least one identification point 112 comprising a first reader 116 configured to read the identifier associated with the tray. In an example embodiment, the identification point 112 may comprise also a second reader 118 configured to read a user identifier. The identification point 112 may also comprise a control unit 114 configured to control the operations of the identification point 112. The identification point 112 may also comprise a display 120 configured to provide information, for example, about the food collected by the user. In an example embodiment, the second reader 118 may comprise a QR code reader or a close range wireless communication reader. In another example embodiment, the second reader 118 may be arranged also at one food serving point 102.

The system may comprise a data system 100 and a training system 124. The data system 100 may be configured to store data relating to food served in each of the plurality of food serving points 102. The data may comprise, for example, the food served by each of the plurality of food serving points 102. Further, the data relating to food served in the plurality of food serving points may comprise detailed information about the food, for example, ingredient data, nutrition content data (relating, for example, to fat, carbohydrate, protein etc.), energy content data, weigh data etc. In other words, the data system 100 may be aware of the recipe content of the food served at the food serving point 102.

The data system 100 may also be configured to obtain the weighing result and the identifier, the example, the identifier of the tray, from each food serving point 102 and associate weighing results having the same identifier with each other. The data system 100 may be configured to start a new session when detecting the identifier obtained with the reader 106 for the first time. The data system 100 may be configured to generate a session having a session identifier when obtaining the identifier (for example, the tray identifier) for the first time and determining that there does not exist an active session associated with the identifier. The data system 100 may be configured to associate a session start time with the session and link the identifier with the session having the session identifier. After the start, subsequent measurement results at the food serving points 102 can be linked to the session based on the obtained identifier. In an example embodiment, the data system 100 may be configured to receive also the sensor data from the at least one sensor and to associate the sensor data with a corresponding weighing result within the session. Alternatively, the sensor data associated with the identifier obtained by the reader 106 may be transmitted directly to the training system 124. The session may also comprise the user identifier. It may be sufficient to read the user identifier once at some location during the session as a single user identification is sufficient.

The training system 124 may be configured to obtain sensor data originating from the at least one sensing point 122, the sensor data being associated with the identifier, obtain the weighing results associated with the identifier and the data relating to food served in the plurality of food serving points from the food serving point from the managing system, and use at least the obtained sensor data associated with the identifier, the weighing results associated with the identifier and the data relating to food served in the plurality of food serving points as training data for a machine learning algorithm to build a model enabling a subsequent classification of food based at least on sensor data associated with the food. Any applicable machine learning algorithm for building the model may be used. For example, if a sensing point 122 is arranged at each food serving point, sensor data may be obtained separately from each food serving point. This leads to an incremental sensor data series in which an increase in weight at a food serving point corresponds to an added element (i.e. the food taken from the food serving point) in the sensor data. For example, the data system 100 may know that a certain food serving point serves rice. The recipe in this case is very simple, and the data system 100 is aware of the nutrition composition of the rice. The weight of the rice taken by the user is obtained from the weighing device. At the sensing point, sensor data (for example, image data) including, for example, the contents of the tray, is captured, and based on the sensor data it is known that the latest added element (i.e. rice) has a certain weight.

When the training data is obtained repeatedly and used as a training data for the machine learning model, the model evolves and becomes more accurate. This then enables a solution in which weighing events and sensing event at the food serving point are no longer needed, as the trained model is able to provide a subsequent classification of food based at least on sensor data associated with the food.

The solution illustrated in FIG. 1A includes detailed information about the food served in the plurality of food serving points. In other words, before a user collects any food from the food serving points, the system is aware of the food that can be collected by the user. Then, when the user starts collecting food from the food collecting points, the amount of food collected by the at each food serving point is weighed. At the same time the sensing point provides sensor data about the collected food with at least one sensor. Based on the sensor data, it may be possible to calculate a volume of the food. It may also be possible to separate, for example, fat, protein, carbohydrate and moisture (for example, vegetables, meat etc. in the collected food can be detected with a spectral camera). When all this information is combined and used as a training data for the machine learning algorithm, a model enabling a subsequent classification of food based at least on sensor data associated with the food can be obtained. In other words, when the model has been trained, less information (for example, only sensor data obtained from one or more sensors) is sufficient for providing an estimation of the content of food collected by a user). Further, the illustrated solution may enable also a calculation of intake of the user (weigh/mass) and dietary contents.

FIG. 1B illustrates a system according to an example embodiment. The embodiment illustrated in FIG. 1B is similar to the one illustrated in FIG. 1A with the exception that the sensing point 126 is now located at the identification point 112. In other words, no separate sensing points are arranged at respective food serving points 102. Instead, a single sensing point 126 is applied at the identification point 112, for example, at a cashing point. The sensor data associated with the identifier obtained by the reader 116 may be transmitted to the data system 100. Alternatively or additionally, the sensor data associated with the identifier obtained by the reader 116 may be transmitted directly to the training system 124.

FIG. 1C illustrates a system according to an example embodiment. The embodiment illustrated in FIG. 1C is similar to the one illustrated in FIG. 1A with the exception that the system additionally comprises at least one waste collecting point 126.

The at least one waste collecting point 138 may comprise a control unit 128 connected to a reader 130 configured to read the identifier associated with the tray when the tray is returned. The waste collecting point 138 may further at least one weighing device 132 connected to the control unit 128 and configured to weigh the amount of biowaste left by a user to the waste collection point 138. The management unit 100 may be configured to receive from the control unit 128 the identifier associated with the tray and weighed weight of the biowaste. The waste collecting point 138 may also comprise a display 134 connected to the control unit 128. The display 134 may display, for example, the weight of the biowaste left by the user. The at least one waste collecting point 138 may additionally comprise a sensing point 136 comprising at least one sensor configured to provide sensor data about the food left by the user. The at least one sensor may comprise at least of the following: a camera, a stereo camera, a depth camera, a multispectral camera, an infrared camera, a RGB camera, a spectroscopy sensor, a near infrared sensor, a spectroscopy sensor, a photogrammetry sensor, a lidar sensor, a three-dimensional scanner and a photodetector. One or more of the sensors may be configured to detect at wavelengths of 200-1700 nm, 280-1550 nm, 315-1380 nm, 380-1000 nm, 390-900 nm or 400-800 nm. The sensing point 136 may be positioned so that the at least one sensor is able to provide sensor data, for example, image data about the food left by the user. The waste collecting point 138 may be connected to the data system 100.

Additionally, the sensor data associated with the identifier obtained by the reader 130 may be transmitted directly to the training system 124.

In an example embodiment, the training system 124 may be configured to obtain the waste weighing result, the food collecting session identifier associated with the food collecting session of the user and the sensor data about the food left by the user; and provide based on the obtained waste weighing result, the food collecting session identifier associated with the food collecting session of the user and the sensor data about the food left by the user additional information about the food left by the user. The additional information may comprise, for example, food items left by the user and/or the amount of different food items in the waste left by the user. In an example embodiment, the training system 124 may use the previously built model for providing the additional information. In another example embodiment, a separate model may be built for the food waste based on based on the food left by the users at the waste collecting point 138. As the data system 100 is aware of the food served at the food serving points 102 and the amount of food taken by the users, the training system 124 is able to use also this information when providing additional information about the food left by the users. For example, when a user proceeds to the waste collecting point 138 and the identifier is read, it is already known that the user collected, for example, 150 g rice and 150 g chicken sauce from the food serving points 102. This then means that, for this specific user, the food left by the user may contain rice and chicken sauce thus considerably limiting the alternatives what the user may leave as waste food at the waste collecting point 138, and thus facilitating the classification of the waste food.

In an example embodiment, the data system 100 may be configured to end an existing session associated with the identifier when failing to register the identifier 144 at the waste collection point 138 within a predetermined period of time, for example, 45 minutes. Thus, the term “session” may define a time period within which the same user uses the same identifier (for example, by controlling the tray from a first food serving point until returning the tray at the waste collection point or a separate tray returning point. If there is a separate tray returning point, it may comprise a reader configured to read the identifier when the tray is returned. This enables a termination of the session even if the return of the tray was not registered in a normal manner, for example, if the user left the tray on a table.

The solution illustrated in FIG. 1C includes detailed information about the food served in the plurality of food serving points. In other words, before a user collects any food from the food serving points, the system is aware of the food that can be collected by the user. Then, when the user starts collecting food from the food collecting points, the amount of food collected by the at each food serving point is weighed. At the same time the sensing point provides sensor data about the collected food with at least one sensor. Based on the sensor data, it may be possible to separate, for example, fat, protein, carbohydrate and moisture (for example, vegetables, meat etc. in the collected food). This knowledge can be utilized also at the waste collecting point 138. By using the data collected at the time of food collection, sensor data provided by the sensing point 136 and one or more weighing results from the weighing device 132, it is possible to determine, for example, the nutrient content consumed by the user.

FIG. 1D illustrates a system according to an example embodiment. The embodiment illustrated in FIG. 1D is similar to the one illustrated in FIG. 1C with the exception that the sensing point 126 is now located at the identification point 112.

In an example embodiment of any of FIGS. 1A-1D, the system may comprise a management interface connected to the training system 124. The training system 124 may be configured to obtain additional sensor data and manually labeled data associated with the additional sensor data from the management interface, and use the obtained additional image data and manually labeled data as training data for the machine learning algorithm to complement the model. In an example embodiment, the training system 124 may be configured to obtain also weighing data associated with the new food item or dish. This may be useful, for example, where a new food item or dish is introduced in the system and the training system has not earlier been provided with sensor data (and possibly weighing data) about this item or dish. As there is no earlier data, the model trained by the training system is not able to classify the new food item or dish. However, via the management interface, the new food item or dish can be learned and included in the trained model, and after a sufficient amount of training, the model is able to classify the new food item or dish when it is introduced at the food serving points 122.

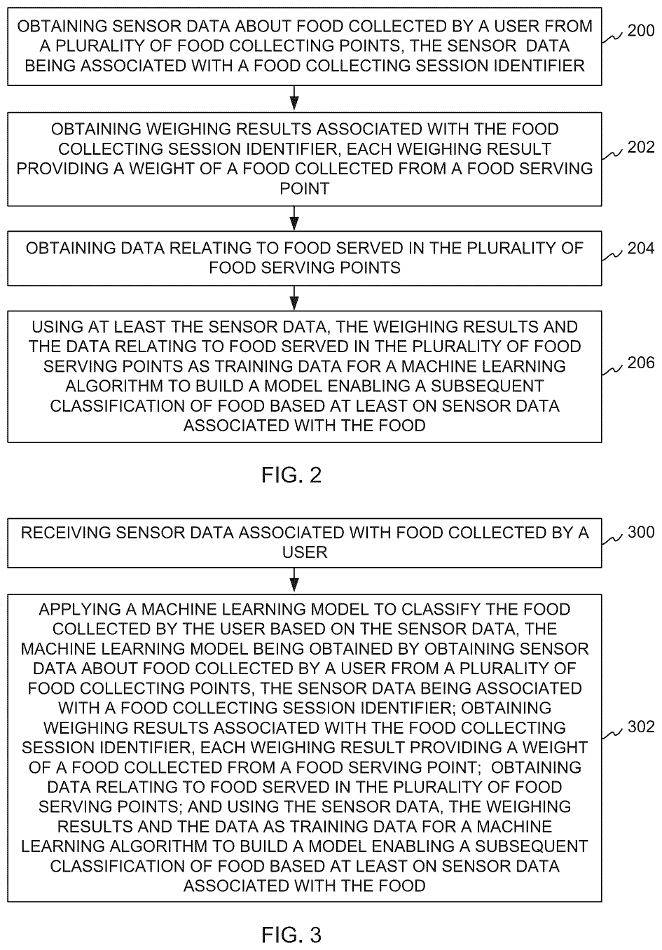

FIG. 2 illustrates a signaling diagram of a method according to an example embodiment. The method may be a computer-implemented method performed, for example, by an apparatus included in the training system 124.

At 200, sensor data about food collected by a user from a plurality of food serving points is obtained, the sensor data being associated with a food collecting session identifier. The data may be obtained from the data system 100 or directly from the plurality of food serving points.

At 202, weighing results associated with the food collecting session identifier are obtained, each weighing result providing a weight of a food collected from a food serving point. The data may be obtained from the data system 100 or directly from the plurality of food serving points.

At 204, data relating to food served in the plurality of food serving points is obtained. The data may be obtained from the data system 100.

At 206, at least the sensor data, the weighing results and the data are used as training data for a machine learning algorithm to build a model enabling a subsequent classification of food based at least on sensor data associated with the food. In an example embodiment, the data used as a training data may comprise sensor data or image data obtained from other sources, for example, the internet or an image bank, representing similar food collections. The data relating to food served in the plurality of food serving points may comprise detailed information about the food, for example, ingredient data, nutrition content data (relating, for example, to fat, carbohydrate, protein etc.), energy content data, weigh data etc. One or more of the sensors may be configured to detect at wavelengths of 200-1700 nm, 280-1550 nm, 315-1380 nm, 380-1000 nm, 390-900 nm or 400-800 nm.

In an example embodiment, sensor data associated with food collected by a user may be received, and the model is applied to classify the food collected by the user based on the sensor data. In an further example embodiment, a weighing result associated with the food collected by the user may be received, and the model may be applied to classify the food collected by the user based on the sensor data and the weighing result. In other words, when the model has been built, then based on only limited amount of data (the sensor data, or the sensor data and the weighing result) it is possible to classify the food collected by the user. The sensor data and the weighing result may be collected, for example, at a single point, for example, at a cashier, when the user has collected the food. Thus, food collecting specific sensing points and weighing device are no longer needed in order to obtain data about the food collected by the user.

FIG. 3 illustrates a signaling diagram of a method according to another example embodiment. The method may be a computer-implemented method performed, for example, by an apparatus including a trained machine learning model.

At 300, sensor data associated with food collected by a user is received.

At 302, a trained machine learning model to classify the food collected by the user based on the sensor data is applied. The machine learning model has been obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food. In an example embodiment, the method may further comprise receiving a weighing result associated with the food collected by the user; and applying the trained model to classify the food collected by the user based on the sensor data and the weighing result.

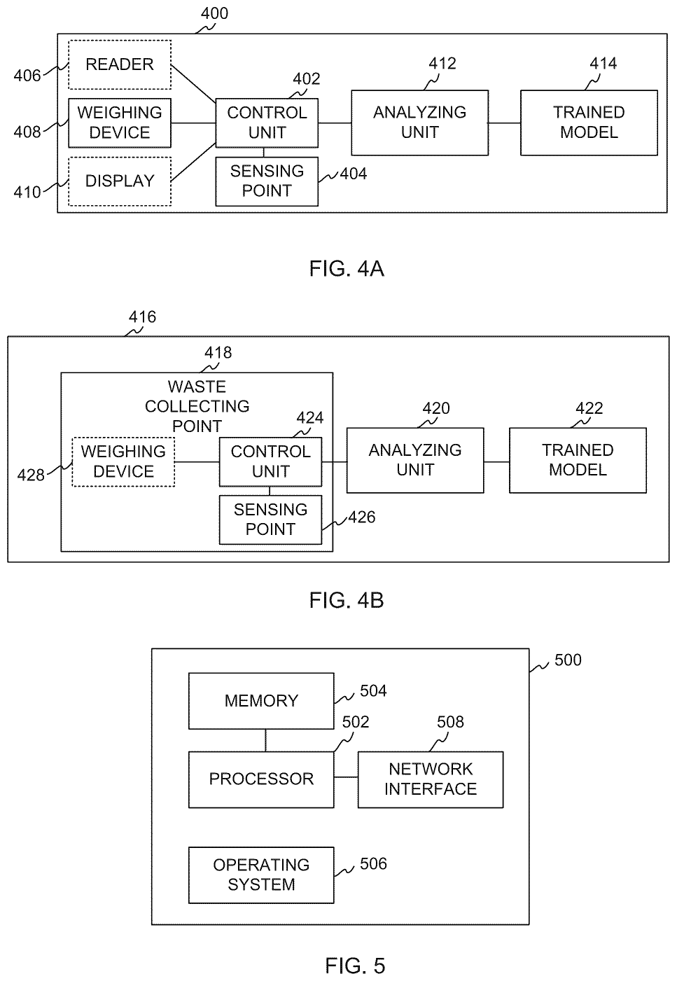

FIG. 4A illustrates a system according to an example embodiment.

The system 400 may comprise a reader 406 configured to read an identifier. The identifier may be associated, for example, to a user or to a mobile device of the user. The system 400 may also comprise a control unit 402 configured to control the operations of the identification point 400. The system 400 may also comprise a display 410 configured to provide information, for example, about the food collected by the user. The reader 406 may be, for example, QR code reader, a close range wireless communication reader or a camera. The system 400 may further comprise a weighing device 408 configured to weigh the amount of food collected by the user. The control unit 402 may use some approximation or predefined information about the weight of other items on a tray, for example, a plate, a glass, cutlery etc. in order to determine the actual weight of the food.

The system 400 may further comprise a sensing point 404. The sensing point 404 may comprise at least one sensor configured to provide sensor data about the food collected by the user. The at least one sensor may comprise at least of the following: a camera, a stereo camera, a depth camera, a multispectral camera, an infrared camera, a RGB camera, a spectroscopy sensor, a near infrared sensor, a spectroscopy sensor, a photogrammetry sensor, a lidar sensor, a three-dimensional scanner and a photodetector. One or more of the sensors may be configured to detect at wavelengths of 200-1700 nm, 280-1550 nm, 315-1380 nm, 380-1000 nm, 390-900 nm or 400-800 nm. The sensing point 404 may be positioned so that the at least one sensor is able to provide sensor data, for example, image data about the food collected by the user. One possible location for the at least one sensor may be above a counter on which the tray is placed when the user is about to pay for the food. Thus, the at least one sensor is able to store the sensor data about the food collected by the user. The data provided associated with the identifier provided by the at least one sensor may be provided to an analyzing unit 412.

The system 400 may further comprise an analyzing unit 412 and a trained machine learning model 414. The trained machine learning model 414 may have been trained earlier with a system and functionality illustrated in more detail in any of FIGS. 1A-1D and the associated description. The analyzing unit 412 may be configured apply the trained model 414 to classify the food collected by the user based on the sensor data, or based on the sensor data and the weighing result provided by the weighing device 408. In an example embodiment, the analyzing unit 412 may have access to detailed information about the food served at a location comprising the system 400, for example, food served at the location, nutrition content of the feed etc. In an example embodiment, functionality relating to the control unit 402, the analyzing unit 412 and the trained model 414 may be provided by a single entity comprising a memory storing the trained model.

Based on the sensor data, the weighing result and the trained model, the analyzing unit 412 may be able to provide an estimation or a classification of the food taken by the user. For example, the estimation or classification result may be that the user has taken 150 g rice and 150 g chicken sauce. If the user was identified by the system 400, the estimation or classification result may be associated with the user.

FIG. 4B illustrates a system 416 according to an example embodiment.

The system 416 may be implemented with a waste collection point 418. The system 416 may comprise a control unit 424 configured to control the operations of the waste collection point 418. The system 416 may further comprise a weighing device 428 configured to weigh the amount of food left by the user. The system 416 may further comprise a sensing point 426. The sensing point 426 may comprise at least one sensor configured to provide sensor data about the food left by the user. The at least one sensor may comprise at least of the following: a camera, a stereo camera, a depth camera, a multispectral camera, an infrared camera, a RGB camera, a spectroscopy sensor, a near infrared sensor, a spectroscopy sensor, a photogrammetry sensor, a lidar sensor, a three-dimensional scanner and a photodetector. One or more of the sensors may be configured to detect at wavelengths of 200-1700 nm, 280-1550 nm, 315-1380 nm, 380-1000 nm, 390-900 nm or 400-800 nm. The sensing point 426 may be positioned so that the at least one sensor is able to provide sensor data, for example, image data about the food left by the user. One possible location for the at least one sensor may be above a counter on which the tray is placed when the user is about to enter the waste collection point. Thus, the at least one sensor is able to store the sensor data about the food left by the user. The sensor data provided by the at least one sensor may be provided to an analyzing unit 420.

The system 416 may further comprise an analyzing unit 422 and a trained machine learning model 422. The trained machine learning model 422 may have been trained earlier with a system and functionality illustrated in more detail in any of FIGS. 1A-1D and the associated description. In another example embodiment, the system 416 may use some general machine learning model as the trained model 422. The analyzing unit 420 may be configured apply the trained model 422 to classify the food collected by the user based on the sensor data, or based on the sensor data and the weighing result provided by the weighing device 428. In an example embodiment, the analyzing unit 420 may have access to detailed information about the food served at a location comprising the system 416, for example, food served at the location, nutrition content of the feed etc. In another example embodiment, the analyzing unit 420 does not have any preset information available. In an example embodiment, functionality relating to the control unit 424, the analyzing unit 420 and the trained model 422 may be provided by a single entity comprising a memory storing the trained model.

Based on the sensor data and the trained model 422, and possible also based on the weighing result from the weighing device 428, the analyzing unit 420 may be able to provide an estimation or a classification of the food left by the user. The analyzing unit 420 may be able separate the food content of the food left by the user, for example, meat, sauce, salad, bread, or even the nutrient content associated with the food left by the user.

One or more of the examples and embodiments discussed above may enable a solution to estimate food content based on a limited amount of sensor data, for example, image data by using the trained model. Further, one or more of the examples and embodiments discussed above may enable a solution that provides detailed information about overall food consumption and the amount and type of food waste by the users.

Further, one or more of the examples and embodiments discussed above may enable a solution to provide a user based historical food content analysis when the user is identified during a food collection process. Further, one or more of the examples and embodiments discussed above may enable a solution in which an end user is able to make use of the data provided by the illustrated system, for example, to personal purposed, for example, to monitoring health and/or a diet. Further, one or more of the examples and embodiments discussed above may enable a solution for planning an applicable diet for a person. This may also take into account, for example, existing medical issues (for example, medication, illnesses etc.) of a person.

FIG. 5 illustrates an apparatus 500 that may include a variety of optional hardware and software components. The apparatus 500 can include one or more controllers or processors 502 (e.g., signal processor, microprocessor, ASIC, or other control and processing logic circuitry) for performing such tasks as signal coding, data processing, input/output processing, power control, and/or other functions, and a network interface 508 enabling wireless and/or wired data communication.

The apparatus 500 can also include a memory or memories 504. The memory 504 can include a non-removable memory and/or a removable memory. The non-removable memory can include RAM, ROM, flash memory, a hard disk, or other well-known memory storage technologies. The removable memory can include flash memory or other well-known memory storage technologies. The memory 504 can be used for storing data and/or code for running an operating system 506 and/or one or more applications.

The apparatus 500 may be configured to implement the various features, examples and embodiments illustrated, for example, in FIGS. 1A-1D, 2, 3 and 4A-4B partially or completely. The functionality described herein can be performed, at least in part, by one or more computer program product components such as software components. The system or apparatus may comprise a single apparatus or multiple apparatuses, and it can provide a cloud-based service that is accessible via a data communication network, for example, the internet.

According to an example embodiment, the processor 502 may be configured by the program code which when executed performs the examples and embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs). The system or apparatus may additionally include components and elements not disclosed in FIG. 5, for example, input/output interfaces, a receiver, a transmitter, a transceiver, input/output ports, a display etc.

Any combination of the illustrated components disclosed in FIG. 5, for example, at least one of the processor 502 and the memory 504 may constitute means for performing any of the illustrated functionality herein.

Those skilled in the art should understand that each step or operation, or any combinations of the steps or operation mentioned above, can be implemented by various means, such as hardware, firmware, and/or software. As an example, one or more of the steps or operation described above can be embodied by computer or processor executable instructions, data structures, program modules, and other suitable data representations. Furthermore, the computer executable instructions which embody the steps or operation described above can be stored on a corresponding data carrier and executed by at least one processor like the processor included in the apparatus. This data carrier can be implemented as any computer-readable storage medium configured to be readable by said at least one processor to execute the computer executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology (for example, solid state drive (SSD) or NVM Express (NVMe)), CD-ROM, digital versatile discs (DVD), holographic media or other optical disc storage, magnetic tape, magnetic cassettes, magnetic disk storage, and other magnetic storage devices.

Although the example embodiments of the present invention are disclosed herein, it should be noted that any various changes and modifications could be made in the embodiments of the present invention, without departing from the scope of legal protection which is defined by the appended claims. In the appended claims, the mention of elements in a singular form does not exclude the presence of the plurality of such elements, if not explicitly stated otherwise.

1. A system comprising:
a plurality of food serving points configured to serve food, each food serving point being configured to serve a predetermined dish, each food serving point being associated with a weighing device configured to weigh the amount of the food collected from the food serving point to provide a weighing result, and a reader configured to read an identifier associated with a food collecting session of a user;
at least one sensing point, each sensing point comprising at least one sensor configured to provide sensor data about the food collected by the user and a reader configured to read the identifier associated with the food collecting session of the user;
a data system configured to
store data relating to food served in each of the plurality of food serving points;
obtain the weighing result and the identifier from each food serving point; and
associate weighing results having the same identifier with each other;
a training system configured to
obtain sensor data originating from the at least one sensing point, the sensor data being associated with the identifier;
obtain the weighing results associated with the identifier and the data relating to food served in the plurality of food serving points from the data system; and
use the obtained sensor data associated with the identifier, the weighing results associated with the identifier and the data relating to food served in the plurality of food serving points as training data for a machine learning algorithm to build a model enabling a subsequent classification of food based at least on sensor data associated with the food.

2. The system of claim 1, further comprising a control unit configured to:
receive a trigger event; and
trigger storing of sensor data of the food collected by the user with the at least one sensor.

3. The system of claim 2, wherein the control unit is configured to receive the trigger event from the reader.

4. The system of claim 1, further comprising a control unit and a sensing point at each of the plurality of food serving points, the control unit of a food serving point being configured to:
receive a trigger event; and
trigger storing of sensor data associated with the food collected by the user with the at least one sensor of the sensing point.

5. The system of claim 4, wherein the control unit is configured to receive the trigger event from the reader associated with the food serving point.

6. The system of claim 4, wherein the control unit is configured to receive the trigger event from the weighing device associated with the food serving point.

7. The system of claim 1, wherein the data relating to food served in the plurality of food serving points comprises at least one of:
the food served by each of the plurality of food serving points; and
nutrient content information associated with each food served by each of the plurality of food serving points.

8. The system of claim 1, wherein the data system is configured to:
generate a session having a session identifier when obtaining the identifier for the first time and determining that there does not exist an active session;
associate a session start time with the session; and
link the identifier with the session having the session identifier.

9. The system of any claim 8, further comprising user identifier reader, and the data system is configured to:
obtain a user identifier from the user identifier reader; and
associate the user identifier with the session.

10. The system of claim 1, wherein the identifier comprises a radio frequency identifier, a near filed communication identifier, a bar code, a QR code or a visually recognizable identifier associated with a tray used by the user.

11. The system of claim 1, wherein the identifier comprises an identifier, a radio frequency identifier, a near filed communication identifier, a smart wearable identifier, a smart ring identifier, a fingerprint, a biometric identifier and a visually recognizable identifier associated with the user.

12. The system of claim 1, further comprising a waste collecting point comprising:
a weighing device configured to weigh the amount of biowaste left by the user to provide a waste weighing result;
a reader configured to read the food collecting session identifier associated with the food collecting session of the user; and
at least one sensor configured to provide sensor data about the food left by the user,
wherein the training system is configured to:
obtain the waste weighing result, the food collecting session identifier associated with the food collecting session of the user and the sensor data about the food left by the user; and
provide based on the obtained waste weighing result, the food collecting session identifier associated with the food collecting session of the user and the sensor data about the food left by the user additional information about the food left by the user.

13. The system of claim 1, wherein the at least one sensor comprise at least one of a camera, a stereo camera, a depth camera, a multispectral camera, a hyperspectral camera, an infrared camera, a RGB camera, an ultraviolet camera a spectroscopy sensor, a near infrared sensor, a spectroscopy sensor, a photogrammetry sensor, a lidar sensor, a three-dimensional scanner and a photodetector.

14. The system of claim 1, wherein the training system is configured to:
obtain additional sensor data and manually labeled data associated with the additional sensor data; and
use the obtained additional sensor data and manually labeled data as training data for the machine learning algorithm to complement the model.

15. A computer-implemented method comprising:
obtaining sensor data about food collected by a user from a plurality of food serving points, the sensor data being associated with a food collecting session identifier;
obtaining weighing results associated with the food collecting session identifier, each weighing result providing a weight of a food collected from a food serving point;
obtaining data relating to food served in the plurality of food serving points; and
using at least the sensor data, the weighing results and the data relating to food served in the plurality of food serving points as training data for a machine learning algorithm to build a model enabling a subsequent classification of food based at least on sensor data associated with the food.

16.-20. (canceled)

21. The computer program comprising instructions for causing an apparatus to perform the method of claim 15.

22. An apparatus comprising:
at least one processor; and
at least one memory including computer program code,
the at least one memory and the computer program code configured to, with the at least one processor, cause the apparatus at least to:
obtain sensor data about food collected by a user from a plurality of food serving points, the sensor data being associated with a food collecting session identifier;
obtain weighing results associated with the food collecting session identifier, each weighing result providing a weight of a food collected from a food serving point;
obtain data relating to food served in the plurality of food serving points; and
use at least the sensor data, the weighing results and the data relating to food served in the plurality of food serving points as training data for a machine learning algorithm to build a model enabling a subsequent classification of food based at least on sensor data associated with the food.

23.-27. (canceled)

28. A computer-implemented method comprising:
receiving sensor data associated with food collected by a user; and
applying a trained machine learning model to classify the food collected by the user based on the sensor data, the trained machine learning model being obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

29. (canceled)

30. An apparatus comprising:
at least one processor; and
at least one memory including computer program code, the at least one memory and the computer program code configured to, with the at least one processor, cause the apparatus at least to:
receive sensor data associated with food collected by a user; and
apply a trained machine learning model to classify the food collected by the user based on the sensor data, the trained machine learning model being obtained by obtaining sensor data about food collected by a user from a plurality of food serving points, the sensor data being associated with a food collecting session identifier; obtaining weighing results associated with the food collecting session identifier, each weighing result providing a weight of a food collected from a food serving point; obtaining data relating to food served in the plurality of food serving points; and using at least the sensor data, the weighing results and the data as training data for a machine learning algorithm to build a model enabling a subsequent classification of food based at least on sensor data associated with the food.

31. (canceled)

32. The computer program comprising instructions for causing an apparatus to perform the method of claim 18.

33. A system comprising:
a sensing point comprising at least one sensor configured to provide sensor data about food collected by a user;
a control unit configured to control the sensing point; and
an analyzing unit configured to configured apply a trained model to classify the food collected by the user based at least on the sensor data to provide an estimation and/or a classification of the food taken by the user.

34. (canceled)

35. A system comprising:
a sensing point comprising at least one sensor configured to provide sensor data about food left by a user;
a control unit configured to control the sensing point; and
an analyzing unit configured to configured apply a trained model to classify the food left by the user based at least on the sensor data to provide an estimation and/or a classification of the food left by the user.

36. (canceled)
